(19) United States
(12) Patent Application Publication
(10) Pub. No.: US 2026/0308460 A1
(43) Pub. Date: Oct. 8, 2026

(54) COUNTER-CURRENT DOWNER REACTOR FOR CATALYTIC CRACKING TESTING SYSTEM AND METHOD

(71) Applicants: Saudi Arabian Oil Company, Dhahran (SA); King Abdullah University of Science and Technology, Thuwal (SA)

(72) Inventors: Mengmeng Cui, Thuwal (SA); Pedro Castano, Thuwal (SA); Talal Aldugman, Thuwal (SA); Khalid Ali Almajnouni, Jeddah (SA); Lujain R. Alfilfil, Thuwal (SA); Nikolaos Papagiannis, Thuwal (SA); Isa Al Aslani, Thuwal (SA); Jorge Gascon Sabate, Thuwal (SA)

(73) Assignees: Saudi Arabian Oil Company, Dhahran (SA); King Abdullah University of Science and Technology, Thuwal (SA)

(21) Appl. No.: 19/236,427

(22) Filed: Jun. 12, 2025

Related U.S. Application Data
(63) Continuation of application No. PCT/GR2025/050009, filed on Apr. 3, 2025.

(51) Int. Cl. C10G 11/18

(52) U.S. Cl. CPC C10G 11/18

(57) ABSTRACT

Methods for processing hydrocarbons may include introducing a hydrocarbon feed stream into a reactor vessel through a hydrocarbon feed inlet proximate a bottom end of the reactor vessel, introducing a catalyst into the reactor vessel through a catalyst inlet proximate a top end of the reactor vessel, and contacting the hydrocarbon feed stream with the catalyst in a reaction zone of the reactor vessel in a counter-current orientation to produce a cracked hydrocarbon stream and a spent catalyst. The hydrocarbon feed stream may be introduced into the reactor vessel by passing the hydrocarbon feed stream through a fluid distribution ring of a hydrocarbon feed inlet. The catalyst may be introduced into the reactor vessel through the catalyst inlet by passing a fluidization gas through a fluid distribution ring into a catalyst container housing a catalyst feed, and then passing the catalyst from the catalyst container to the catalyst inlet.

### CROSS-REFERENCE TO RELATED APPLICATIONS

The present application is a bypass continuation of and claims priority to International Application No. PCT/GR2025/050009, filed Apr. 3, 2025, the contents of which are incorporated by reference herein in their entirety.

### TECHNICAL FIELD

Embodiments of the present disclosure generally relate to systems and methods for processing hydrocarbons and, more specifically, to systems and methods for processing hydrocarbons to produce olefins.

### BACKGROUND

Olefins, including ethylene, propylene, and butylene, are basic intermediates used by a large portion of the petrochemical industry. Traditionally, olefins are produced by thermal cracking of petroleum fractions such as naphtha, kerosene, or gas oil. However, olefins may also be produced through refinery fluidized catalytic cracking (FCC) processes. The production of olefins such as ethylene, propene, and butylene has attracted increased attention as purified olefin streams are considered the building blocks for various polymers and chemicals. The production of light olefins depends on several process variables, such as the feed type, operating conditions, and the type of catalyst. To address the increasing demand for light olefins, there is a need for improved methods for processing hydrocarbons to produce olefins.

### SUMMARY

Described herein are catalytic cracking methods and systems utilized for processing hydrocarbons. In particular, the methods and systems described herein utilize counter-current downer reactors with fluid distribution rings. In some embodiments, such fluid distribution rings may be used for passing a hydrocarbon feed stream into a reactor through the fluid distribution ring. In additional embodiments, the fluid distribution ring may be used for passing a fluidization gas through the fluid distribution ring. It has been discovered that the utilization of such fluid distribution rings may increase uniformity in injection, whereas conventional systems that do not utilize such fluid distribution rings may suffer from maldistribution of injected materials.

According to one or more embodiments, a method for processing hydrocarbons comprises introducing a hydrocarbon feed stream into a reactor vessel through a hydrocarbon feed inlet proximate a bottom end of the reactor vessel by passing the hydrocarbon feed stream through a fluid distribution ring of the hydrocarbon feed inlet, introducing a catalyst into the reactor vessel through a catalyst inlet proximate a top end of the reactor vessel, and contacting the hydrocarbon feed stream with the catalyst in a reaction zone of the reactor vessel to produce a cracked hydrocarbon stream and a spent catalyst, wherein the hydrocarbon feed stream has a net upward superficial velocity through the reaction zone and the catalyst has a net downward superficial velocity through the reaction zone, wherein the fluid distribution ring comprises: a housing defining a central bore at an axial center of the housing and a distribution chamber surrounding the central bore in a radial direction and separated from the central bore by an inner wall; a fluid inlet extending through an outer wall of the housing from an exterior of the housing to the distribution chamber; and a plurality of distribution channels extending through the inner wall of the housing and fluidly connecting the distribution chamber to the central bore.

According to one or more embodiments, a method for processing hydrocarbons comprises introducing a hydrocarbon feed stream into a reactor vessel through a hydrocarbon feed inlet proximate a bottom end of the reactor vessel, introducing a catalyst into the reactor vessel through a catalyst inlet proximate a top end of the reactor vessel, and contacting the hydrocarbon feed stream with the catalyst in a reaction zone of the reactor vessel to produce a cracked hydrocarbon stream and a spent catalyst, wherein the hydrocarbon feed stream has a net upward superficial velocity through the reaction zone and the catalyst has a net downward superficial velocity through the reaction zone, wherein the catalyst is introduced into the reactor vessel through the catalyst inlet proximate the top end of the reactor vessel by: passing a fluidization gas through a fluid distribution ring into a catalyst container housing a catalyst feed, and passing the catalyst from the catalyst container to the catalyst inlet, and wherein the fluid distribution ring comprises: a housing defining a central bore at an axial center of the housing and a distribution chamber surrounding the central bore in a radial direction and separated from the central bore by an inner wall; a fluid inlet extending through an outer wall of the housing from an exterior of the housing to the distribution chamber; and a plurality of distribution channels extending through the inner wall of the housing and fluidly connecting the distribution chamber to the central bore.

According to one or more embodiments, a fluidized catalytic cracking (FCC) system comprises: a reactor vessel comprising an elongated reaction tube having a substantially vertical orientation, a top end, and a bottom end; a hydrocarbon feed inlet proximate the bottom end of the reactor vessel; a catalyst inlet proximate the top end of the reactor vessel; a catalyst container configured to house a catalyst feed; and a fluid distribution ring comprising: a housing defining a central bore at an axial center of the housing and a distribution chamber surrounding the central bore in a radial direction and separated from the central bore by an inner wall; a fluid inlet extending through an outer wall of the housing from an exterior of the housing to the distribution chamber; and a plurality of distribution channels extending through the inner wall of the housing and fluidly connecting the distribution chamber to the central bore; wherein the FCC system is a laboratory-scale testing unit, and wherein: the hydrocarbon feed inlet comprises the fluid distribution ring, and wherein the fluid distribution ring is configured to inject the hydrocarbon feed stream into the reactor vessel; or the catalyst container comprises the fluid distribution ring, and wherein the fluid distribution ring is configured to fluidize the catalyst feed in the catalyst container.

### BRIEF DESCRIPTION OF THE DRAWINGS

The following detailed description of specific embodiments of the present disclosure can be best understood when read in conjunction with the following drawings, where like structure is indicated with like reference numerals and in which:

FIG. 1 schematically depicts a reactor system having a batch reactor configuration, according to one or more embodiments disclosed herein;

FIG. 2 schematically depicts a cross-sectional view of a fluid distribution ring, according to one or more embodiments disclosed herein;

FIG. 3 schematically depicts an exploded view of the fluid distribution ring shown in FIG. 2, according to one or more embodiments disclosed herein;

FIG. 4 is a planar projection of a portion of an inner surface of an inner wall of the fluid distribution ring shown in FIG. 2, showing the circumferential and vertical spacing between distributions channels, according to one or more embodiments disclosed herein;

FIG. 5 schematically depicts a cross-section of a fluid distribution ring having a frustum shape according to one or more embodiments disclosed herein;

FIG. 6A depicts a side view of a catalyst distributor, according to one or more embodiments disclosed herein;

FIG. 6B depicts a top view of a catalyst distributor, according to one or more embodiments disclosed herein;

FIG. 7A depicts a side view of a catalyst distributor, according to one or more embodiments disclosed herein;

FIG. 7B depicts a top view of a perforated plate of the catalyst distributor shown in FIG. 7A, according to one or more embodiments disclosed herein;

FIG. 7C depicts a cross-sectional view of the perforated plate shown in FIG. 7B, according to one or more embodiments disclosed herein;

FIG. 8A depicts a side view of a catalyst distributor, according to one or more embodiments disclosed herein;

FIG. 8B depicts a top view of a perforated plate of the catalyst distributor shown in FIG. 8A, according to one or more embodiments disclosed herein;

FIG. 8C depicts a cross-sectional view of a perforated plate, according to one or more embodiments disclosed herein;

FIG. 9 graphically depicts modeling results showing average axial particle velocity (x-axis) versus height (y-axis) for a co-current downer and a counter-current downer, according to an example of the present disclosure;

FIG. 10 graphically depicts modeling results showing average solid holdup (x-axis) versus height (y-axis) for a co-current downer and a counter-current downer, according to an example of the present disclosure;

FIG. 11 graphically depicts modeling results showing average solid holdup (y-axis) versus time (x-axis) at selected heights for a co-current downer, according to an example of the present disclosure; and

FIG. 12 graphically depicts modeling results showing average solid holdup (y-axis) versus time (x-axis) at selected heights for a counter-current downer, according to an example of the present disclosure.

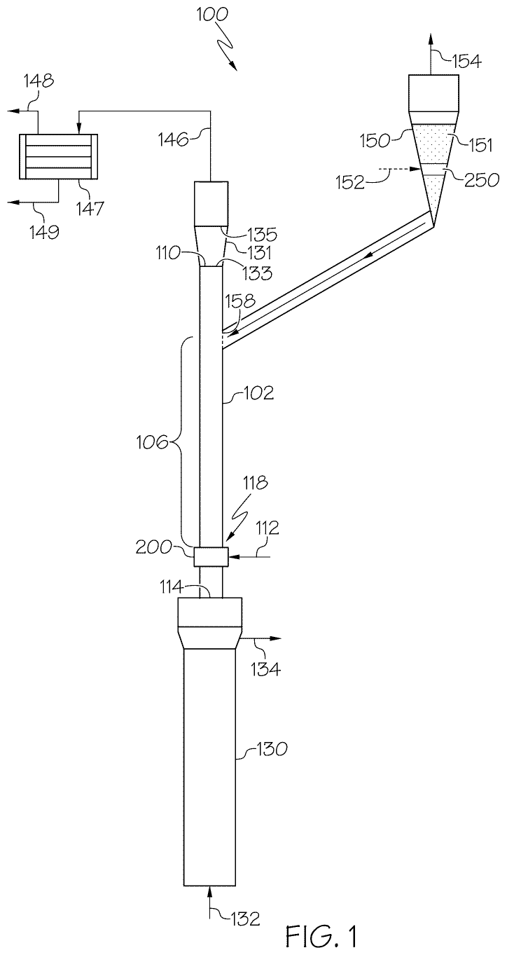

For the purpose of describing the simplified schematic illustrations and descriptions of FIGS. 1-8C, the numerous valves, temperature sensors, electronic controllers and the like that may be employed and well known to those of ordinary skill in the art of certain chemical processing operations are not included. Further, accompanying components that are often included in typical chemical processing operations, such as air supplies, catalyst hoppers, and flue gas handling systems, are not all necessarily depicted. Accompanying components that are in cracking units, such as bleed streams, spent catalyst discharge subsystems, and catalyst replacement subsystems are also not shown. It should be understood that these components are within the spirit and scope of the present embodiments disclosed. It should be understood that the reactor diameter should not be inferred from the drawings and that the diameter of the reactor may be similar or different to the depiction in the drawings. Additionally, operational components, such as those described in the present disclosure, may be added to the embodiments described in this disclosure.

It should further be noted that arrows in the drawings refer to process streams. However, the arrows may equivalently refer to transfer lines which may serve to transfer process streams between two or more system components. Additionally, arrows that connect to system components define inlets or outlets in each given system component. The arrow direction corresponds generally with the major direction of movement of the materials of the stream contained within the physical transfer line signified by the arrow. Furthermore, arrows which do not connect two or more system components signify a product stream which exits the depicted system or a system inlet stream which enters the depicted system. Product streams may be further processed in accompanying chemical processing systems or may be commercialized as end products. System inlet streams may be streams transferred from accompanying chemical processing systems or may be non-processed feedstock streams. Some arrows may represent recycle streams, which are effluent streams of system components that are recycled back into the system. However, it should be understood that any represented recycle stream, in some embodiments, may be replaced by a system inlet stream of the same material, and that a portion of a recycle stream may exit the system as a system product.

Additionally, arrows in the drawings may schematically depict process steps of transporting a stream from one system component to another system component. For example, an arrow from one system component pointing to another system component may represent “passing” a system component effluent to another system component, which may include the contents of a process stream “exiting” or being “removed” from one system component and “introducing” the contents of that product stream to another system component.

Reference will now be made in greater detail to various embodiments, some embodiments of which are illustrated in the accompanying drawings. Whenever possible, the same reference numerals will be used throughout the drawings to refer to the same or similar parts.

### DETAILED DESCRIPTION

FCC reactors are considered one of the central components for the conversion of bottom of the barrel hydrocarbons into lighter products including light olefins and middle distillates. However, the development of FCC testing systems and methods for studying the influence of process, catalyst, and feed conditions remains an area of intense activity. In particular, there is a need for addressing new challenges in the proper extrapolation of data extracted from the laboratory units to the industrial scale. While virtually all refinery or catalyst producers possess a laboratory protocol for catalyst evaluation and process development, existing testing practices generally rely on the fixed or fluidized beds, including the microactivity test (MAT) unit, advanced catalytic experiment (ACE) unit, Berty type riser simulator, and transported beds as microriser. However, these conventional testing units may be less accurate for reproducing the same heat and mass transfer characteristics and gas-solid contact under realistic conditions, especially regarding coke formation. In addition, for riser simulators, it is very difficult to collect the whole liquid product, especially smaller than C₁₆ hydrocarbons, out of microliters of injected oil. Therefore, there remains a need for an easily operated laboratory-scale unit able to produce cracking data under operating conditions that are more representative of industrial plant operating conditions for assessing the catalyst performance, operating conditions, and feed flexibility for counter-current reactor configurations.

The reactor systems of the present disclosure incorporate fluid distribution rings, described in detail herein, as a component of the hydrocarbon feed inlet for uniformly injecting the hydrocarbon feed stream and/or as a component of the catalyst container for uniformly injecting fluidization gas for improved fluidization and heating of the catalyst feed in the catalyst container. This utilization may be particularly well-suited for laboratory-scale FCC testing units. In particular, in some embodiments, the uniform injection of the hydrocarbon feed stream into the reactor vessel through fluid distribution rings described herein results in improved contact and mass transfer between hydrocarbons and the catalyst upon introduction of the hydrocarbon feed stream into the reactor vessel. The improved contact and mass transfer between hydrocarbons and the catalyst better represents industrial conditions and allows for the study of intrinsic kinetics to evaluate the feed, catalyst, and process in a counter-current contact pattern. Further, in some embodiments, the uniform injection of fluidization gas into the catalyst container through a fluid distribution ring described herein reduces heat transfer limitations and thereby facilitates the uniform and efficient heating of the catalyst feed prior to introduction into the reactor vessel. The uniform introduction of the hydrocarbon feed stream into the reactor vessel and/or the uniform introduction of fluidization gas into the catalyst container thus allow for a laboratory-scale FCC testing unit that can be used to investigate intrinsic kinetics associated with the process conditions, catalyst characteristics, and or hydrocarbon feed composition. The improved uniformity allows the data collected using the laboratory-scale FCC testing units of the present disclosure to be extrapolated to the industrial scale with more reliability than conventional FCC testing units.

Some embodiments of the present disclosure are directed to methods for processing hydrocarbons. The methods for processing hydrocarbons may comprise introducing a hydrocarbon feed stream into a reactor vessel (e.g., a single reactor vessel) through a hydrocarbon feed inlet proximate a bottom end of the reactor vessel, introducing a catalyst into the reactor vessel through a catalyst inlet proximate a top end of the reactor vessel, and contacting the hydrocarbon feed stream with the catalyst in a reaction zone of the reactor vessel to produce a cracked hydrocarbon stream and a spent catalyst, wherein the hydrocarbon feed stream has a net upward superficial velocity through the reaction zone and the catalyst has a net downward superficial velocity through the reaction zone. The hydrocarbon feed stream may be contacted with the catalyst in a counter-current orientation to form a cracked hydrocarbon stream. As the hydrocarbon feed stream and the catalyst move in opposite directions, the counter-current operation provides a unique contact pattern between the catalyst and hydrocarbons that includes an initial feed cracking with partially deactivated catalysts followed by a subsequent deep cracking of intermediate molecules upon contact with fresh catalysts, which also offers high potentiality for FCC processes with petrochemicals as the targeted products such as, for example, one or more of ethylene, propylene, and butylene. This reactor configuration allows for a high catalyst/reactant ratio and an enhanced contact pattern between the catalyst and hydrocarbons with improved heat and mass transfer. Moreover, this reactor configuration reduces back mixing and allows for a narrower residence time distribution for the catalyst and hydrocarbons, which may improve the selectivity of the targeted products. Each of these features may improve the yield of desired olefin products.

In one or more embodiments, the hydrocarbon feed stream may be introduced into the reactor vessel by passing the hydrocarbon feed stream through a fluid distribution ring of a hydrocarbon feed inlet, where the fluid distribution ring is configured to uniformly inject the hydrocarbon feed stream into the reaction zone of the reactor vessel, thereby leading to improved gas-solid contact and improved mass transfer. The fluid distribution ring may comprise a housing defining a central bore at an axial center of the housing and a distribution chamber surrounding the central bore in a radial direction and separated from the central bore by an inner wall, a fluid inlet extending through an outer wall of the housing from an exterior of the housing to the distribution chamber, and a plurality of distribution channels extending through the inner wall of the housing and fluidly connecting the distribution chamber to the central bore.

In one or more embodiments, introducing the catalyst into the reactor vessel through the catalyst inlet comprises passing a fluidization gas through a fluid distribution ring into a catalyst container housing a catalyst feed, and passing the catalyst from the catalyst container to the catalyst inlet, wherein the fluid distribution ring comprises the same general structural features as described above for the fluid distribution ring of the hydrocarbon feed inlet, namely, a housing defining a central bore at an axial center of the housing and a distribution chamber surrounding the central bore in a radial direction and separated from the central bore by an inner wall, a fluid inlet extending through an outer wall of the housing from an exterior of the housing to the distribution chamber, and a plurality of distribution channels extending through the inner wall of the housing and fluidly connecting the distribution chamber to the central bore.

The indefinite articles “a” and “an” are employed to describe elements and components of the present disclosure. The use of these articles means that one or at least one of these elements or components is present. Although these articles are conventionally employed to signify that the modified noun is a singular noun, as used herein the articles “a” and “an” also include the plural, unless otherwise stated in specific instances. Similarly, the definite article “the,” as used in the present disclosure, also signifies that the modified noun may be singular or plural, unless otherwise stated in specific instances.

As used in this disclosure, passing a stream or effluent from one unit “directly” to another unit refers to passing the stream or effluent from the first unit to the second unit without passing the stream or effluent through an intervening reaction system or separation system that substantially changes the composition of the stream or effluent, such as through chemical reaction or through preferential separation of one or more constituents from the stream or effluent. Heat transfer devices, such as heat exchangers, preheaters, coolers, condensers, or other heat transfer equipment, and pressure devices, such as pumps, pressure regulators, compressors, or other pressure devices, are not considered to be intervening systems that change the composition of a stream or effluent, unless otherwise specifically stated in the present disclosure. Combining two streams or effluents together upstream of a process unit also is not considered to comprise an intervening system that changes the composition of one or both of the streams or effluents being combined. Simply dividing a stream into two streams having the same composition is also not considered to comprise an intervening system that changes the composition of the stream.

As used in this disclosure, a “reactor” refers to a vessel in which one or more chemical reactions may occur between one or more reactants optionally in the presence of one or more catalysts. For example, a reactor may include a tank or tubular reactor configured to operate as a batch reactor, a continuous reactor, or a plug flow reactor. Example reactors include packed bed reactors, such as fixed bed reactors, and fluidized bed reactors. One or more “reaction zones” may be disposed in a reactor. As used in this disclosure, a “reaction zone” refers to an area where a particular reaction takes place in a reactor.

As used in this disclosure, the term “counter-current” may be used to describe the relationship between process streams flowing in substantially opposite directions where the process streams flow past or through one another. For example, a first process stream flowing in a substantially downward direction may flow counter-current to a second process stream flowing in a substantially upward direction. The direction of the flow of a stream may be in the same direction as the superficial velocity of that stream. As used throughout the present disclosure, the term “counter-current reactor” may be used to describe reactors in which catalyst and reactants and/or products flow through a reactor in a counter-current orientation.

As described herein, “superficial velocity” refers to the velocity at which an individual phase flows through a given cross-sectional area. The net flow of a phase is used to determine superficial velocity of that phase; thus, individual particles or molecules within a phase may move in a direction different from, or even opposite to, the net flow of a phase without affecting the direction of the superficial velocity of that phase. In some embodiments, the superficial velocity of catalyst moving through the reaction zone may be in a substantially downward direction.

As used in this disclosure, a “catalyst” refers to any substance which increases the rate of a specific chemical reaction. Catalysts described in this disclosure may be utilized to promote various reactions, such as, but not limited to, cracking. As used in this disclosure, “cracking” generally refers to a chemical reaction where a molecule having carbon to carbon bonds is broken into more than one molecule by the breaking of one or more of the carbon to carbon bonds, or is converted from a compound which includes a cyclic moiety, such as a cycloalkane, cycloalkane, naphthalene, an aromatic or the like, to a compound which does not include a cyclic moiety or contains fewer cyclic moieties than prior to cracking.

As used in this disclosure, the term “spent catalyst” refers to catalyst that has been contacted with reactants at reaction conditions in a reaction zone to catalyze a chemical reaction, but has not been subsequently regenerated in a regenerator or subjected to an in-place regeneration process in the reactor following contact with the reactants. The “spent catalyst” may have coke deposited on the catalyst and may include partially coked catalyst as well as fully coked catalysts. The amount of coke deposited on the “spent catalyst” may be greater than the amount of coke remaining on the regenerated catalyst following regeneration.

As used in this disclosure, the term “regenerated catalyst” refers to catalyst that has been contacted with reactants at reaction conditions in a reaction zone to catalyze a chemical reaction and then regenerated in a regenerator or subjected to an in-place regeneration process to heat the catalyst to a greater temperature, oxidize and remove at least a portion of the coke from the catalyst to restore at least a portion of the catalytic activity of the catalyst, or both. The “regenerated catalyst” may have less coke, a greater temperature, or both compared to spent catalyst and may have greater catalytic activity compared to spent catalyst. The “regenerated catalyst” may have more coke and lesser catalytic activity compared to fresh catalyst that has not passed through a cracking reaction zone and regenerator.

As used in this disclosure, the term “fresh catalyst” refers to catalyst that has not been previously contacted with reactants at reaction conditions in a reaction zone.

As used herein with respect to the size of the FCC systems described herein, the term “laboratory-scale” indicates that the FCC system has the capability to process catalyst flow between 10 and 400 g min⁻¹ and hydrocarbon flow from 1 to 20 g min⁻¹ under the catalyst/oil ratio within 60, dilution ratio (steam or inert/oil) within 5, and gas/solid residence time within 30 seconds (e.g., within 10 to 30 seconds).

Referring now to FIG. 1, a reactor system 100 for producing olefins is schematically depicted in a batch reactor configuration. The reactor system 100 comprises a reactor vessel 102 comprising an elongated reaction tube having a substantially vertical orientation, a top end 110, and a bottom end 114. In some embodiments, the elongated reaction tube having a “substantially vertical orientation” means that a central axis of the elongated reaction tube forms an angle of at most 10 degrees with respect to the direction of gravity. The reactor system 100 further comprises a hydrocarbon feed inlet 118 proximate the bottom end 114 of the reactor vessel 102 and a catalyst inlet 158 proximate the top end 110 of the reactor vessel 102. Proximate generally refers to “nearby” in relative terms in the context of the overall architecture of the system. As used herein, the phrase “proximate the top end 110 of the reactor vessel 102” may refer to positions that are within a distance from the top end 110 of the reactor vessel 102 that is less than 20%, less than 10%, or less than 5% of the length of the reactor vessel 102 (i.e., distance between the top end 110 and the bottom end 114). As used herein, the phrase “proximate the bottom end 114 of the reactor vessel 102” may refer to positions that are within a distance from the bottom end 114 of the reactor vessel 102 that is less than 20%, less than 10%, or less than 5% of the length of the reactor vessel 102. The reactor system 100 may further comprise a catalyst container 150 configured to house a catalyst feed 151. The portion of the reactor vessel 102 between the hydrocarbon feed inlet 118 and the catalyst inlet 158 may define a reaction zone 106 of the reactor vessel 102.

The reactor system 100 may be operable to introduce a hydrocarbon feed stream 112 into the reactor vessel 102 through the hydrocarbon feed inlet 118 proximate the bottom end 114 of the reactor vessel 102, to introduce a catalyst into the reactor vessel 102 through the catalyst inlet 158 proximate the top end 110 of the reactor vessel 102, and to contact the hydrocarbon feed stream 112 with the catalyst in the reaction zone 106 of the reactor vessel 102 to produce a cracked hydrocarbon stream and a spent catalyst, wherein the hydrocarbon feed stream 112 has a net upward superficial velocity through the reaction zone 106 and the catalyst has a net downward superficial velocity through the reaction zone 106. The reactor system 100 may be operable to contact the hydrocarbon feed stream 112 with the catalyst under reaction conditions sufficient to cause at least a portion of the hydrocarbon feed stream 112 to undergo cracking to produce light olefins such as, but not limited to, ethylene, propylene, and butylene, which may be present in a product stream 146 of the reactor system 100.

The hydrocarbon feed stream 112 and the catalyst contact each other in the reaction zone 106 in a counter-current manner. Without intending to be bound by theory, counter-current flow between the hydrocarbon feed stream 112 and the catalyst may result in an increased yield of olefins by allowing the more reactive chemicals in the hydrocarbon feed stream 112 to contact less active catalyst, and less active catalyst to contact more reactive chemicals in the hydrocarbon feed. Generally, catalyst may become spent as it moved down through the reaction zone 106. Accordingly, more active catalyst may contact less reactive hydrocarbons near the top of the reaction zone 106, where the catalyst is introduced, and less active catalyst may contact more reactive hydrocarbons near the bottom of the reaction zone 106, where the hydrocarbon feed stream 112 is introduced. Additionally, counter-current contact of catalyst and hydrocarbons may reduce a catalyst acceleration zone, where catalyst is less uniformly distributed within the reaction zone. This may improve system stability and enhance contact between the catalyst and the hydrocarbons. These effects may improve the yield of desired olefin products.

The spent catalyst may exit the reactor vessel 102 through a catalyst outlet positioned at or proximate to the bottom end 114 of the reactor vessel 102. The cracked hydrocarbon stream may exit the top of the reaction zone 106 and flow with a net upward superficial velocity toward the top end 110 of the reactor vessel 102. In some embodiments, the cracked hydrocarbon stream produced in the reaction zone 106 may undergo further cracking as it flows between the reaction zone 106 and the top end 110 of the reactor vessel 102. Further, in one or more embodiments, a portion of the spent catalyst may also exit the top of the reaction zone 106 and flow with a net upward superficial velocity toward the top end 110 of the reactor vessel 102, moving co-currently with the cracked hydrocarbon stream.

According to one or more embodiments, the reaction zone 106 may operate with a turbulent fluidization regime. As described herein, a “turbulent fluidization regime” is similar to the transition regime from bubbling to lean phase fluidization in riser reactors. At relatively low gas velocities, particles flow downwards under gravity in dilute phase. Moreover, with the increasing gas velocity, the downward movement of particles is suspended, leading to the generation of solid clusters in a turbulent motion and voids of gas in various sizes and shapes for a dense solid status. In contrast to a bubbling regime, in a turbulent fluidization regime the tendency for bubble breakage is enhanced as the gas velocity increases. For this reason, the mean bubble size may be significantly smaller than in a bubbling fluidization regime, hence a turbulent fluidized bed may result in more uniform gas-solid contact. However, at relatively high gas velocities within a turbulent fluidization regime, pronounced radial gradients may occur with a greater concentration of solids in the wall region, while the core has a smaller concentration of solids.

In one or more embodiments, a residence time of the catalyst in the reaction zone 106 is less than or equal to 30 seconds. For example, the residence time of the catalyst in the reaction zone 106 may be less than or equal to 30 seconds, 20 seconds, or even 15 seconds. As used herein, “residence time” refers to the average length of time a substance is in a given location. Without intending to be bound by theory, when the residence time of the catalyst in the reaction zone 106 is less than 30 seconds, fewer undesirable secondary reactions may occur that decrease the yield of desired olefin products. In one or more embodiments, a residence time of the gas in the reaction zone 106 may be less than or equal to 10 seconds.

In one or more embodiments, a temperature within the reaction zone 106 may be from 420° C. to 750° C. For example, the temperature within the reaction zone 106 may be from 420° C. to 750° C., from 420° C. to 750° C., from 460° C. to 750° C., from 500° C. to 750° C., from 540° C. to 750° C., from 580° C. to 750° C., from 620° C. to 750° C., from 660° C. to 750° C., 700° C. to 750° C., from 420° C. to 710° C., from 420° C. to 670° C., from 420° C. to 630° C., from 420° C. to 590° C., from 420° C. to 550° C., from 420° C. to 510° C., or any range or combination of ranges formed from these endpoints. In some embodiments, the temperature within the reaction zone 106 may be from 440° C. to 720° C. or from 480° C. to 680° C.

In one or more embodiments, the product stream 146 may comprise C₂ to C₄ olefins among other reaction products. For example, the product stream 146 may comprise ethylene, propylene, butylene, or a combination thereof. In some embodiments, the product stream 146 may comprise other reaction products in addition to C₂ to C₄ olefins. For example, the product stream 146 may further comprise dry gas, aromatics, naphtha, light cycle oil, heavy cycle oil, and even heavy oil.

The hydrocarbon feed stream 112 may include a mixture of hydrocarbon materials. The hydrocarbon materials of the hydrocarbon feed stream 112 may include a crude oil or hydrocarbons derived from crude oil. As used in this disclosure, the term “crude oil” refers to a mixture of petroleum liquids and gases, including impurities such as sulfur-containing compounds, nitrogen-containing compounds and metal compounds, as distinguished from fractions of crude oil, such as fractions obtained from separating the crude oil by boiling point temperature. The hydrocarbon feed stream 112 may include, but may not be limited to, crude oil, vacuum residue, tar sands, bitumen, atmospheric residue, vacuum gas oils, demetalized oils, naphtha streams, gas condensate streams, or combinations of these materials. The hydrocarbon feed stream 112 may include one or a plurality of non-hydrocarbon constituents, such as one or more heavy metals, sulphur compounds, nitrogen compounds, inorganic components, or other non-hydrocarbon compounds. Crude oils contemplated herein include those having an API gravity of from 25° to 50°, such as from 25° to 40°, from 25° to 30°, from 30° to 35°, from 35° to 40°, from 40° to 45°, from 45° to 50°, or any combination of these ranges. In some embodiments, the hydrocarbon feed stream 112 may comprise a fraction of crude oil, or a petrochemical product formed from a crude oil, having an initial boiling point of at least 25° C. For example, In some embodiments, the hydrocarbon feed stream 112 may comprise light naphtha and may have an initial boiling point from 25° C. to 35° C. and a final boiling point of from 85° C. to 95° C. In some embodiments, the hydrocarbon feed stream 112 may comprise heavy naphtha and may have an initial boiling point from 80° C. to 95° C. and a final boiling point from 190° C. to 210° C. In further embodiments, the hydrocarbon feed stream 112 may comprise full range naphtha and have an initial boiling point from 25° C. to 35° C. and a final boiling point from 190° C. to 210° C.

In one or more embodiments, the hydrocarbon feed stream 112 may comprise one or more of C₄ components, light naphtha, heavy naphtha, full range naphtha, vacuum gas oil, crude oil, FCC gasoline, olefinic naphtha, atmospheric residue, vacuum residue, condensate, deasphalted crude oil, dewaxed crude oil, deasphalted-dewaxed crude oil, kerosene, diesel, or methanol. In one or more embodiments, the hydrocarbon feed stream 112 may comprise one or more hydrocarbon streams comprising paraffins, olefins, or both. In one or more embodiments, the hydrocarbon feed stream 112 may be diluted by steam or an inert gas such as nitrogen or argon to adjust the hydrocarbon partial pressure in the system. In such embodiments, the dilution ratio of steam or inert gas to hydrocarbons may be less than or equal to five.

In some embodiments, the catalyst may comprise a zeolite catalyst, such as but not limited to a zeolite Y (e.g., USY zeolite), a ZSM-5 zeolite, or a combination of multiple types of suitable zeolite catalysts. Alternatively or additionally, the catalyst may comprise other suitable solid acid catalysts. In some embodiments, the catalyst may comprise fresh catalyst, regenerated catalyst, or combinations of fresh and regenerated catalyst as described in further detail herein. In some embodiments, the catalyst may comprise binders, cracking promoters, inert fillers, matrix materials, or combinations of these to have acceptable physical and chemical properties to the catalyst, such as but not limited to catalyst attrition index and catalyst density, so that the catalyst can be used in the proposed reactor configuration.

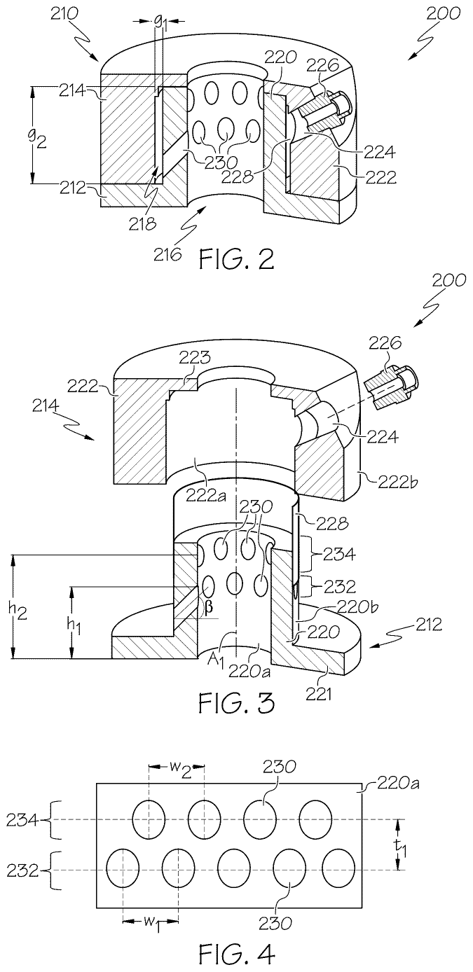

With reference now to FIGS. 1, 2, and 3, in one or more embodiments, the hydrocarbon feed inlet 118 may comprise a fluid distribution ring 200 comprising a housing 210 defining a central bore 216 at an axial center of the housing 210 and a distribution chamber 218 surrounding the central bore 216 in a radial direction and separated from the central bore 216 by an inner wall 220. The fluid distribution ring 200 further comprises at least one fluid inlet 224 extending through an outer wall 222 of the housing 210 from an exterior of the housing 210 to the distribution chamber 218. The fluid distribution ring 200 further comprises a plurality of distribution channels 230 extending through the inner wall 220 of the housing 210 and fluidly connecting the distribution chamber 218 to the central bore 216. As shown in FIGS. 2 and 3, the central bore 216 may have a cylindrical shape and the distribution chamber 218 may have an annular shape. However, the central bore 216 and the distribution chamber 218 may be shaped and sized in any suitable manner, provided the distribution chamber 218 surrounds the central bore 216.

In some embodiments, the reactor system 100 may be operable to introduce the hydrocarbon feed stream 112 into the reactor vessel 102 through the hydrocarbon feed inlet 118 proximate the bottom end 114 of the reactor vessel 102 by passing the hydrocarbon feed stream 112 through a fluid distribution ring 200 of the hydrocarbon feed inlet 118. In one or more embodiments of the methods described herein, the hydrocarbon feed inlet 118 may comprise the fluid distribution ring 200, and the hydrocarbon feed stream 112 may be introduced into the reactor vessel 102 through the hydrocarbon feed inlet 118 by passing the hydrocarbon feed stream 112 through the fluid distribution ring 200 of the hydrocarbon feed inlet 118.

In some embodiments, the housing 210 may comprise an inner housing member 212 and an outer housing member 214. The inner housing member 212 may comprise a lower wall 221 and the inner wall 220, wherein the inner wall 220 extends in a substantially perpendicular direction from the lower wall 221 at a radially inward location of the lower wall 221, as shown in FIG. 3. The outer housing member 214 may comprise an upper wall 223 and the outer wall 222, wherein the outer wall 222 extends in a substantially perpendicular direction from the upper wall 223 at a radially outward location of the upper wall 223, as shown in FIG. 3. The inner housing member 212 and the outer housing member 214 may be coupled together by aligning the central axes of the inner housing member 212 and the outer housing member 214 along central axis A1 and moving the inner and outer housing members 212, 214 towards each other such that an upper end of the inner wall 220 contacts the upper wall 223 of the outer housing member 214 and/or the lower end of the outer wall 222 contacts the lower wall 221 of the inner housing member 212.

The fluid inlet 224 may be configured (e.g., sized and/or threaded) to receive a fluid inlet adapter 226 that injects the hydrocarbon feed stream 112 into the distribution chamber 218 of the fluid distribution ring 200. Once injected into the distribution chamber 218, hydrocarbons of the hydrocarbon feed stream 112 may flow circumferentially around the distribution chamber 218 and pass through the plurality of distribution channels 230 into the central bore 216. In one or more embodiments, the fluid distribution ring 200 further comprises a mesh 228 positioned between the central bore 216 and the distribution chamber 218 and configured to prevent the passage of particles (e.g., catalyst particles) from the central bore 216 to the distribution chamber 218. In some embodiments, the mesh 228 may be disposed on an outer surface 220b of the inner wall 220, as shown in FIG. 3. However, in other embodiments, the mesh 228 may be disposed on the inner surface 220a of the inner wall 220.

Referring to FIG. 2, the radial thickness g₁ of the distribution chamber 218 may be defined by the difference between the diameter of the inner surface 222a of the outer wall 222 and the diameter of the outer surface 220b of the inner wall 220. In some embodiments, the radial thickness g₁ of the distribution chamber 218 may be less than or equal to 3 cm. The distribution chamber 218 may comprise a height g₂ along the axial direction of the housing 210 less than or equal to 10 cm.

Referring again to FIG. 3, in one or more embodiments, each distribution channel 230 of the plurality of distribution chambers 230 may extend through the inner wall 220 towards the central bore 216 at an elevation angle β of greater than or equal to 10° and less than or equal to 80°, greater than or equal to 20° and less than or equal to 80°, greater than or equal to 30° and less than or equal to 80°, greater than or equal to 40° and less than or equal to 80°, greater than or equal to 10° and less than or equal to 50°, or greater than or equal to 60° and less than or equal to 80°. Without wishing to be bound by theory, it is believed that distribution channels 230 extending toward the central bore 216 at an elevation angle β, and the associated upward gas flow, may lead to more uniform gas-solid mixing by improving the contact dynamics between the hydrocarbons of the hydrocarbon feed stream 112 and the catalyst particles which have a net downward superficial velocity in the reaction vessel 102 at the location where the hydrocarbon feed inlet 118 is provided.

In one or more embodiments, each distribution channel 230 of the plurality of distribution chambers 230 may have an equivalent diameter (i.e., diameter of a circle having the same cross-sectional area) of greater than or equal to 3.175 mm (0.125 inches) and less than or equal to 12.7 mm (0.5 inches). The distribution channels 230 may have any suitable cross-sectional shape with respect to the flow path of fluid through the distribution channels 230, which may be straight (e.g., as shown for the embodiment in FIGS. 2 and 3) or curved. For example, and without limitation, the distribution channels 230 may have a circular, oval, or polygonal cross-sectional shape. In some embodiments, such as the embodiment shown in FIGS. 2 and 3, each distribution channel of the plurality of distribution channels 230 may have the same size and shape. However, in other embodiments, the size and shape of the distribution channels 230 may vary. In some embodiments, the first row 232 of distribution channels 230 comprises between 4 and 12 distribution channels 230. In some embodiments, the second row 234 of distribution channels 230 comprises between 4 and 12 distribution channels 230.

In one or more embodiments, the plurality of distribution channels 230 may be provided in a plurality of rows that enter the central bore 216 at different heights along the central axis A1 of the housing 210. In one or more embodiments, the plurality of distribution channels 230 may comprise a first row 232 of distribution channels 230 and a second row 234 of distribution channels 230. In some embodiments, the distribution channels 230 of the first row 232 may be staggered with respect to the distribution channels 230 of the second row 234. FIG. 4 shows a planar projection of a portion of the inner surface 220a of the inner wall 220 of the fluid distribution ring 200 shown in FIG. 2 to illustrate the circumferential spacing and the vertical spacing between distributions channels of the plurality of distribution channels 230. In some embodiments, the first row 232 of distribution channels 230 may comprise a first circumferential spacing w₁ between adjacent distribution channels 230 of greater than or equal to 3.175 mm (0.125 inches) and less than or equal 12.7 mm (0.5 inches), and the second row 234 of distribution channels 230 may comprise a second circumferential spacing w₂ between adjacent distribution channels 230 of greater than or equal to 3.175 mm (0.125 inches) and less than or equal 12.7 mm (0.5 inches). In some embodiments, the first circumferential spacing w₁ and the a second circumferential spacing w₂ are substantially equal to the equivalent diameter of the distribution channels 230. However, any suitable spacing between adjacent distribution channels 230 may be implemented.

In some embodiments, the distribution channels 230 of the first row 232 may be equally spaced about a circumference of the central bore 216 at a first height h₁ of the central bore 216 at which the distribution channels 230 of the first row 232 enter the central bore 216, and the distribution channels 230 of the second row 234 may be equally spaced about a second circumference of the central bore 216 at a second height h₂ of the central bore 216 at which the distribution channels 230 of the second row 234 enter the central bore 216. In some embodiments, the circumferential spacing between adjacent distribution channels 230 may vary depending on the circumferential positions of the adjacent distribution channels 230 with respect to the fluid inlet(s) 224 of the fluid distribution ring 200. In some embodiments, the first height h₁ and the second height h₂ define a vertical spacing t₁ of greater than or equal to 6.35 mm (0.25 inches) and less than or equal to 25.4 mm (1 inch). Without wishing to be bound by theory, it is believed that this design may maintain the strength of the fluid distribution ring 200 while allowing for an increased number of distribution chambers 230.

Without wishing to be bound by theory, it is believed that the fluid distribution ring 200 allows the hydrocarbon feed stream 112 to be uniformly fed and in some embodiments, atomized, into the reactor vessel 102, thereby leading to improved contact and mass transfer between hydrocarbons and the catalyst upon introduction of the hydrocarbon feed stream 112 into the reactor vessel 102.

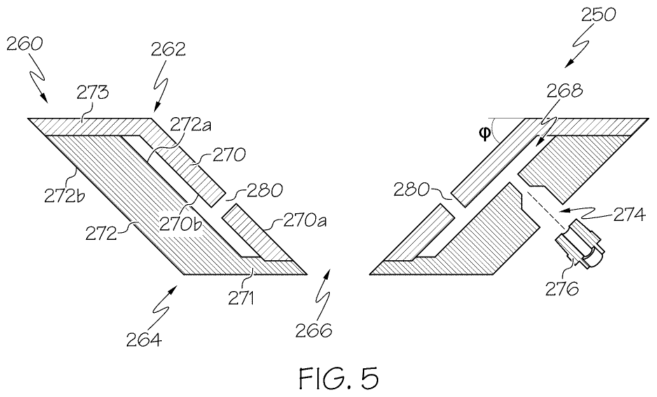

With reference now to FIGS. 1 and 5, in one or more embodiments, the catalyst container 150 may comprise a second fluid distribution ring 250 configured to fluidize the catalyst feed 151 in the catalyst container 150. It should be understood that the reactor systems of the present disclosure may include the second fluid distribution ring 250 in addition to the fluid distribution ring 200 of the hydrocarbon feed inlet 118. However, in other embodiments of the reactor systems described herein, the hydrocarbon feed inlet 118 comprises the fluid distribution ring 200, but the catalyst container 150 does not comprise the second fluid distribution ring 250. Moreover, in other embodiments, the catalyst container 150 comprises the second fluid distribution ring 250, but the hydrocarbon feed inlet 118 does not comprise the fluid distribution ring 200.

The second fluid distribution ring 250 may comprise the same general structural features as the fluid distribution ring 200 of the hydrocarbon feed inlet 118. In particular, the second fluid distribution ring 250 may comprise a second housing 260 defining a second central bore 266 at an axial center of the second housing 260 and a second distribution chamber 268 surrounding the second central bore 266 in a radial direction and separated from the second central bore 266 by a second inner wall 270. The second fluid distribution ring 250 may further comprise a second fluid inlet 274 extending through a second outer wall 272 of the second housing 260 from an exterior of the second housing 260 to the second distribution chamber 268. The second fluid distribution ring 250 may further comprise a second plurality of distribution channels 280 extending through the second inner wall 270 of the second housing 260 and fluidly connecting the second distribution chamber 268 to the second central bore 266. As shown in FIG. 5, the second central bore 266 may have a first frustum shape and the second distribution chamber 268 may have a second frustum shape (i.e., a hollow frustum shape).

In one or more embodiments, the reactor system 100 may be operable to introduce the catalyst into the reactor vessel 102 through the catalyst inlet 158 proximate the top end 110 of the reactor vessel 102 by passing a fluidization gas 152 (e.g., heated air, nitrogen gas, or steam) through the second fluid distribution ring 250 into the catalyst container 150 to fluidize the catalyst feed 151 in the catalyst container 150, and then passing the catalyst from the catalyst container 150 to the catalyst inlet 158. In one or more embodiments of the methods described herein, the catalyst may be passed to the reactor vessel 102 from a catalyst container 150 comprising the second fluid distribution ring 250. The catalyst may be introduced into the reactor vessel 102 through the catalyst inlet 158 by passing a fluidization gas 152 (e.g., heated air, nitrogen gas, or steam) through the second fluid distribution ring 250 into the catalyst container 150 to fluidize the catalyst feed 151 in the catalyst container 150, and then passing the catalyst from the catalyst container 150 to the catalyst inlet 158. The fluidization gas 152 may exit the top of the catalyst container 150 as an exit fluidization gas stream 154.

The catalyst container 150 may have a hopper structure containing an upper cylindrical portion and a lower conical portion (e.g., making up at most 50% of the total height of the catalyst container 150), and the second fluid distribution ring 250 may be provided as part of the lower conical portion, for example, at a height of about 1% to 50%, 5% to 25%, or 5% to 10% of the total height of the catalyst container 150. The catalyst feed 151 in the catalyst container 150 may be fresh catalyst, regenerated catalyst, or a combination of fresh and regenerated catalyst.

The second fluid distribution ring 250 may comprise the same general structural features as the fluid distribution ring 200 of the hydrocarbon feed inlet 118. In particular, the second fluid distribution ring 250 may comprise a second housing 260 defining a second central bore 266 at an axial center of the second housing 260 and a second distribution chamber 268 surrounding the second central bore 266 in a radial direction and separated from the second central bore 266 by a second inner wall 270. The second fluid distribution ring 250 may further comprise a second fluid inlet 274 extending through a second outer wall 272 of the second housing 260 from an exterior of the second housing 260 to the second distribution chamber 268. The second fluid distribution ring 250 may further comprise a second plurality of distribution channels 280 extending through the second inner wall 270 of the second housing 260 and fluidly connecting the second distribution chamber 268 to the second central bore 266. As shown in FIG. 5, the second central bore 266 may have a first frustum shape and the second distribution chamber 268 may have a second frustum shape (i.e., a hollow frustum shape).

In some embodiments, the second housing 260 may comprise an inner housing member 262 and an outer housing member 264. The inner housing member 262 may comprise an upper wall 273 and the second inner wall 270, wherein the second inner wall 270 extends radially inwards and at an angle q from the upper wall 273 at a radially inward location of the upper wall 273, as shown in FIG. 5. The outer housing member 264 may comprise a lower wall 271 and the second outer wall 272, wherein the second outer wall 272 extends radially inwards and at an angle q from the lower wall 271 at a radially outward location of the lower wall 271, as shown in FIG. 5. The inner housing member 262 and the outer housing member 264 may be coupled together by aligning the central axes of the inner housing member 262 and the outer housing member 264 moving the inner and outer housing members 262, 264 towards each other such that a lower end of the second inner wall 270 contacts the lower wall 271 of the outer housing member 264 and/or an upper end of the second outer wall 272 contacts the upper wall 273 of the inner housing member 262. In some embodiments, the size and shape of the second fluid distribution ring 250 (e.g., angle) may be designed based on the geometry of the catalyst container 150.

The second distribution chamber 268 and the second plurality of distribution channels 280 of the second fluid distribution ring 250 may have any of the features described herein with respect to the fluid distribution ring 200 of the hydrocarbon feed inlet 118. For example, like the fluid distribution ring 200 of the hydrocarbon feed inlet 118, the second fluid distribution ring 250 may further comprise a mesh (not shown) positioned between the second central bore 266 and the second distribution chamber 268 and configured to prevent the passage of particles (e.g., catalyst particles) from the second central bore 266 to the second distribution chamber 268. In some embodiments, the mesh may be disposed on an outer surface 270b of the second inner wall 270.

Without wishing to be bound by theory, it is believed that the second fluid distribution ring 250 allows fluidization gas to be uniformly fed into the catalyst container 150 for fluidization of the catalyst feed 151 housed therein. This uniform injection of fluidization gas 152 into the catalyst container 150 reduces heat transfer limitations and thereby facilitates the uniform and efficient heating of the catalyst feed 151. The uniform injection of fluidization gas 152 into the catalyst container 150 also results in a stable catalyst flux into the reactor vessel 102.

In one or more embodiments, the reactor system 100 further comprises a freeboard zone 131 disposed axially above the reactor vessel 102 and in fluid communication with the top end 110 of the reactor vessel 102. The freeboard zone 131 may have an inlet diameter at an inlet 133 of the freeboard zone 131 and an outlet diameter at the outlet 135 of the freeboard zone 131 that is larger than the inlet diameter. The freeboard zone 131 increase in cross-sectional area reduces the superficial velocity of any entrained catalyst within the cracked hydrocarbon fluids to fall back to the top end 110 of the reaction zone 106, thereby allowing for the disengagement of product vapor from the catalyst particles. As vapor and catalyst particles suspended therein enter the freeboard zone 131, the vapor continues to rise due to its upward superficial velocity, while any of the catalyst that is entrained in the vapor phase may fall due the greater density of the catalyst and also due to the decrease in the upward superficial velocity of the vapors in the freeboard zone 131 (resulting from the increase in cross-sectional area). The freeboard zone 131 may decrease the superficial velocity of the vapor phase to a superficial velocity at which the vapors are no longer able to entrain the heavier of the catalyst particles, allowing the catalyst particles to fall back to the top end 110 of the reactor vessel 102. In this way, the freeboard zone 131 assists in separating the vapor from the catalyst.

In one or more embodiments, the reactor system 100 may further comprise one or more condensers 147 configured to receive the product stream 146 and separate the product stream 146 into at least one gas stream 148 and at least one liquid stream 149, each of which may be analyzed to assess and confirm the performance of the reactor system 100. In some embodiments, the reactor system 100 may further comprise a product analyzer (not shown) for analyzing the at least one gas stream 148 and the at least one liquid stream 149 in assessing the performance of the reactor system 100 under set conditions.

In one or more embodiments, the reactor system 100 further comprises a stripping unit 130 in fluid communication with the bottom end of the reactor vessel 102. In the stripping unit 130, at least a portion of hydrocarbons entrained within the spent catalyst may be removed to form a stripped catalyst. The location of the stripping unit 130 relative to the reactor vessel 102 is not necessarily limited. For example, as depicted in FIG. 1, the stripping unit 130 may be integrated with the reactor vessel 102. In some embodiments, the stripping unit 130 may be a standalone unit, positioned apart from the reactor vessel 102.

Without intending to be bound by theory, the catalyst may be porous and hydrocarbons from the hydrocarbon feed stream 112 may be entrained within the pores of the spent catalyst. Removing at least a portion of the hydrocarbons entrained within the pores of the spent catalyst may reduce secondary thermal and catalytic cracking reactions. For example, in embodiments of the systems described herein comprising a regenerator, this may reduce the coke load to the regenerator. The hydrocarbons entrained within the spent catalyst may be removed in the stripping unit 130 by any suitable means. For example, a stripping fluid 132 may be passed to the stripper to contact the spent catalyst to form the stripped catalyst. In one or more embodiments, the stripping fluid 132 may enter the stripping unit 130 at or near the bottom of the stripping unit 130. In some embodiments, the stripping fluid 132 may comprise steam, an inert gas, or both. In one or more embodiments, the stripping fluid 132, after contacting the spent catalyst, may be passed from the stripping unit 130 in stream 134, which may be passed directly to the condenser 147 to maintain the pressure profile in the system.

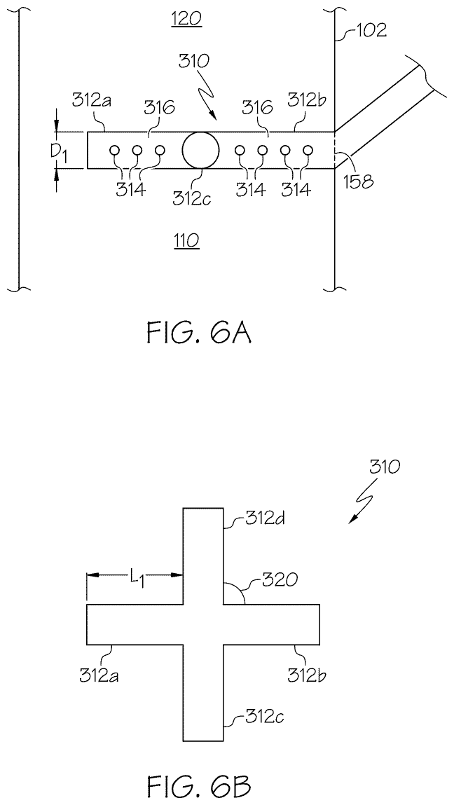

Referring now to FIG. 6A, the introduction of the catalyst into the reactor vessel 102 through the catalyst inlet 158 may further comprise passing the catalyst through a catalyst distributor 310 that is coupled to the catalyst inlet 158 and that extends into the reactor vessel 102. In one or more embodiments, the catalyst distributor 310 may define an upper end of the counter-current reaction zone 106 within the reactor vessel 102. Without intending to be bound by theory, the catalyst distributor 310 may allow for the uniform distribution of catalyst in to the reaction zone 106, which may improve the performance of the reactor system 100, increasing the yield of desired olefin products.

The catalyst distributor 310 may have any suitable shape. Examples of suitable catalyst distributors 310 are depicted in FIGS. 6A-6B, 7A-7C, and 8A-8C.

Referring now to FIGS. 6A and 6B, the catalyst distributor 310 may comprise from 2 to 12 tubular branches 312. For example, the catalyst distributor 310 may comprise 2, 3, 4, 5, 6, 7, 8, 9, 10, 11, or 12 tubular branches 312. In the embodiment depicted in FIGS. 6A and 6B, the catalyst distributor comprises four tubular branches 312a, 312b, 312c, and 312d. Each tubular branch may comprise a plurality of orifices 314 on a circumferential portion 316 of the tubular branch 312. The orifices 314 may be shaped and sized such that the catalyst may pass through the orifices into and above the reaction zone 106.

In one or more embodiments, the tubular branches 312 may be spaced apart radially at an arm angle 320 from 30° to 180° (depending on the number of tubular branches 312) with a plurality of equidistant distributed arms such that catalyst enters the reactor vessel 102 uniformly and the stability of the system is maintained. For example, the tubular branches 312 may be spaced apart radially at an arm angle 320 from 30° to 180°, from 45° to 180°, from 60° to 180°, from 75° to 180°, from 90° to 180°, from 105° to 180°, from 120° to 180°, from 135° to 180°, from 150° to 180°, from 165° to 180°, from 30° to 165°, from 30° to 150°, from 30° to 135°, from 30° to 120°, from 30° to 105°, from 30° to 90°, from 30° to 75°, from 30° to 60°, from 30° to 45°, or any range or combination of ranges formed from these endpoints.

In one or more embodiments, each tubular branch 312 may have a diameter D₁ that is less than or equal to 50% of a diameter of the reactor vessel 102 at the catalyst distributor 310. For example, each tubular branch 312 may have a diameter D₁ that is less than or equal to 50%, 40%, 30%, 20%, or 10% of a diameter of the reactor vessel 102 at the catalyst distributor 310. In one or more embodiments, each tubular branch 312 may have a length Li that is less than or equal to 40% of the diameter of the reactor vessel 102 at the catalyst distributor 310. For example, the each tubular branch 312 may have a length Li that is less than or equal to 40%, 35%, 30%, 25%, 20%, 15%, or 10% of the diameter of the reactor vessel 102 at the catalyst distributor 310.

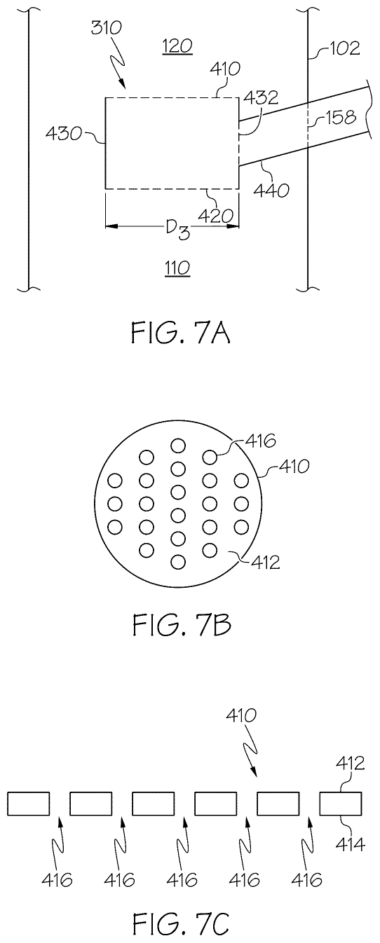

Referring now to FIGS. 7A-7C, the catalyst distributor 310 may comprise a top perforated plate 410, a bottom perforated plate 420, a distributor wall 430 extending from the top perforated plate 410 to the bottom perforated plate 420, and a conduit extending from an opening 432 in the distributor wall 430 to the catalyst inlet 158 in the wall of the reactor vessel 102. The top perforated plate 410 and the bottom perforated plate 420 may extend along a substantially horizontal cross-section of the reactor vessel 102. As described herein, a “substantially horizontal cross-section” may be within 15°, 10°, 5°, or even 1° of horizontal. In one or more embodiments, catalyst may be passed into the catalyst distributor 310 through the catalyst inlet 158. Catalyst may be passed downwards into the reaction zone 106 through the bottom perforated plate 420, and also upwards, above the reaction zone 106, through the top perforated plate 410.

Referring now to FIGS. 7B and 7C, the top perforated plate 410 may have a first major surface 412 and a second major surface 414, the second major surface 414 being opposite the first major surface 412. The top perforated plate 410 may have any suitable shape cross-sectional shape. For example, without limitation, the top perforated plate 410 may have a circular, oval, or polygonal cross-sectional shape, in a cross-section parallel to the first major surface 412 and the second major surface 414 of the top perforated plate 410. Referring to FIG. 7B, the top perforated plate 410 may have a circular cross-sectional shape. In such embodiments, the diameter of the top perforated plate 410 may be less than or equal to 50% of the diameter of the reactor vessel 102 at the catalyst distributor 310. For example, the diameter of the top perforated plate 410 may be less than or equal to 50%, 40%, 30%, or 20% of the diameter of the reactor vessel 102 at the catalyst distributor 310.

The top perforated plate 410 may comprise a plurality of perforations 416. Each perforation 416 may be an opening extending from the first major surface 412 to the second major surface 414 of the top perforated plate 410. The perforations 416 may be sized such that the catalyst may pass through the perforations 416. The perforations 416 may be positioned in any suitable pattern or distribution on the top perforated plate 410 such that the catalyst is uniformly distributed above the reaction zone 106 when the catalyst is passed through the top perforated plate 410. In one or more embodiments, the perforations 416 may be uniformly distributed and sized. The perforations 416 may have any suitable cross-sectional shape. For example, without limitation, the perforations may have a circular, oval, or polygonal cross-sectional shape, in a cross-section parallel to the first major surface 412 and the second major surface 414 of the top perforated plate 410. In one or more embodiments, the perforations are shaped and sized such that catalyst does not accumulate on the top perforated plate 410 and may pass through the top perforated plate 410 smoothly.

It should be understood that the description of the top perforated plate 410 is equally applicable to the bottom perforated plate 420. In one or more embodiments, the top perforated plate 410 and the bottom perforated plate 420 may have the same structure. In some embodiments, the shape top and bottom perforated plates 410, 420 and the distribution of perforations within each plate may be axisymmetric.

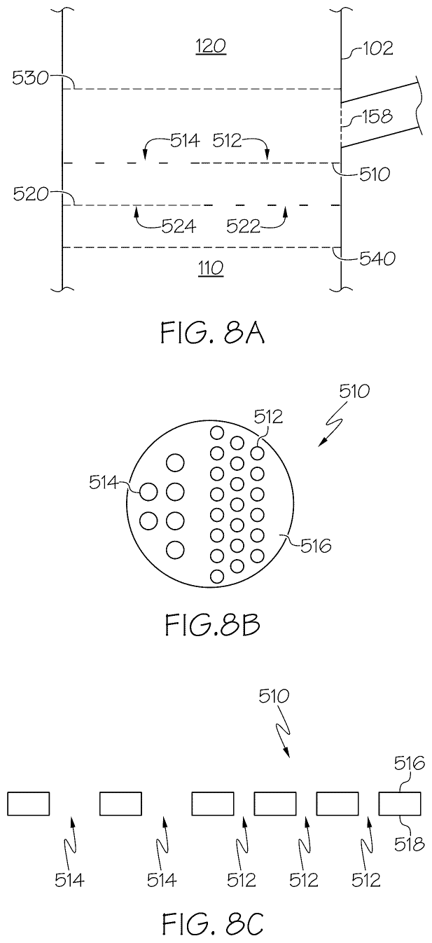

Referring now to FIGS. 8A-8C, the catalyst distributor 310 may comprise a perforated plate 510 extending across the reactor vessel 102. The perforated plate 510 may extend along a substantially horizontal cross-section of the reactor vessel 102. The perforated plate 510 may be positioned below the catalyst inlet 158 in the wall of the reactor vessel 102. In one or more embodiments, the perforated plate 510 may comprise a first major surface 516, a second major surface 518, a first plurality of perforations 512 and a second plurality of perforations 514. The first plurality of perforations 512 are proximate the catalyst inlet 158 in the wall of the reactor vessel 102. In such embodiments, the first plurality of perforations 512 may be closer to the catalyst inlet 158 than the second plurality of perforations 514.

In one or more embodiments, the first plurality of perforations 512 have an average area less than an average area of the second plurality of perforations 514. As described herein, the average area of the first plurality of perforations 512 refers to the average of the open area of each perforation in the first plurality of perforations 512, and the average area of the second plurality of perforations 514 refers to the average of the open area of each perforation in the first plurality of perforations 514. The first plurality of perforations 512 and the second plurality of perforations 514 may have any suitable cross-sectional shape. For example, without limitation, the perforations may have a circular, oval, or polygonal cross-sectional shape, in a cross-section parallel to the first major surface 516 and the second major surface 518 of the perforated plate 510. In one or more embodiments, the first plurality of perforations 512 and the second plurality of perforations 514 may be shaped and sized such that catalyst does not accumulate on the perforated plate 510 and may pass through the perforated plate 510 smoothly. Without intending to be bound by theory, the arrangement of the first plurality of perforations 512 and the second plurality of perforations 514 may improve the uniformity of the distribution of catalyst in the reaction zone 106.

Referring to FIG. 8A, in one or more embodiments, the catalyst distributor 310 may further comprise a second perforated plate 520. The second perforated plate 520 may be positioned below the perforated plate 510. The second perforated plate may comprise a first plurality of perforations 522 and a second plurality of perforations 524. The first plurality of perforations 522 are proximate the catalyst inlet 158 in the wall of the reactor vessel 102. In one or more embodiments, the first plurality of perforations 522 have an average area greater than an average area of the second plurality of perforations 524. In one or more embodiments, the structure of the second perforated plate 520 may be substantially the same as the perforated plate 510 but rotated about 180° in a horizontal plane. Without intending to be bound by theory, the inclusion of the second perforated plate 520 may improve the uniformity of the distribution of catalyst entering the reaction zone 106.

Referring again to FIG. 8A, in one or more embodiments, the catalyst distributor 310 may further comprise a third perforated plate 530 and a fourth perforated plate 540. The third perforated plate 530 may be positioned above the catalyst inlet 158 in the wall of the reactor vessel 102. The fourth perforated plate 540 may be positioned below the second perforated plate 520. In one or more embodiments, the perforations in the third perforated plate 530 and the fourth perforated plate 540 may be uniform. For example, the third perforated plate 530 and the fourth perforated plate 540 may have a structure similar to the top perforated plate 410 depicted in FIGS. 7B and 7C. Without intending to be bound by theory, the third perforated plate 530 may improve the distribution of catalyst entering the reactor vessel 102 above the reaction zone 106, and the fourth perforated plate 540 may improve the distribution of catalyst entering the reaction zone 106.

In one or more embodiments, not depicted in the drawings, the catalyst distributor 310 may comprise one or more perforated plates having the structure of the first perforated plate 510 or the second perforated plate 520 positioned above the catalyst inlet 158. In some embodiments, not depicted, the catalyst distributor 310 may further comprise one or more additional perforated plates having the structure of the first perforated plate 510 or the second perforated plate 520 positioned below the catalyst inlet 158. Furthermore, one or more perforated plates having the structure of the third perforated plate 530 or the fourth perforated plate 540 may be positioned above or below the catalyst inlet 158. The number and position of perforated plates in the catalyst distributor 310 may affect the distribution of catalyst entering the reaction zone 106 and the portion of the reactor vessel 102 above the reaction zone 106. In some embodiments, mechanical vibrations may be applied to the catalyst distributor 310 to avoid local choking. Without wishing to be bound by theory, it is believed that the coupling of catalyst distributors described herein to the catalyst inlet evenly redirects the solids to the vertical direction and decreases the solid acceleration, resulting in a more uniform interaction between the catalyst and hydrocarbons and a shorter system fluctuation targeting enhanced mass transfer.

As noted above, in one or more embodiments of the present disclosure, the reactor system is a laboratory-scale fluidized catalytic cracking (FCC) testing unit. The reactor systems of the present disclosure incorporating, the fluid distribution rings described herein as a component of the hydrocarbon feed inlet for uniformly injecting the hydrocarbon feed stream and/or as a component of the catalyst container for uniformly injecting fluidization gas for improved fluidization and heating of the catalyst feed in the catalyst container, are particularly suited for laboratory-scale FCC testing units. In particular, in some embodiments, the uniform injection of the hydrocarbon feed stream into the reactor vessel through a fluid distribution ring described herein results in improved contact and mass transfer between hydrocarbons and the catalyst upon introduction of the hydrocarbon feed stream into the reactor vessel. The improved contact and mass transfer between hydrocarbons and the catalyst better represents industrial conditions and allows for the study of intrinsic kinetics to evaluate the feed, catalyst, and process in a counter-current contact pattern.

Further, in some embodiments, the uniform injection of fluidization gas into the catalyst container through a fluid distribution ring described herein reduces heat transfer limitations and thereby facilitates the uniform and efficient heating of the catalyst feed prior to introduction into the reactor vessel. The uniform introduction of the hydrocarbon feed stream into the reactor vessel and/or the uniform introduction of fluidization gas into the catalyst container thus allow for a laboratory-scale FCC testing unit that can be used to investigate intrinsic kinetics associated with the process conditions, catalyst characteristics, and or hydrocarbon feed composition. The improved uniformity allows the data collected using the laboratory-scale FCC testing units of the present disclosure to be extrapolated to the industrial scale with more reliability than conventional FCC testing units.

### EXAMPLES

The following examples illustrate one or more features of the present disclosure. The examples are illustrative in nature, and should not be understood to limit the subject matter of the present disclosure.

### Example 1: Simulated Comparison of Co-Current and Counter-Current Downers

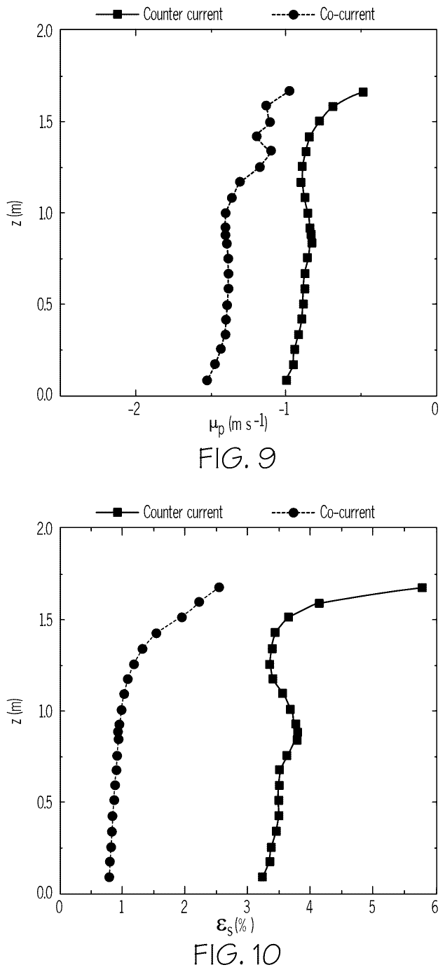

In order to demonstrate the concepts described herein, the hydrodynamics of co-current and counter-current downers were simulated using computational particle fluid dynamics (CPFD) software Barracuda Virtual Reactor (Houston, Texas). The downer reactors were 27 mm in diameter and 1.75 m in height. A typical FCC catalyst was utilized for the simulations (1300 kg m⁻³; average particle size: 93 μm) and inert gas flow (1.63 kg m⁻³; 2.27×10⁻⁵ Pa·s) under conditions of gas velocity U_{g}=40 cm s⁻¹ and particle mass flow rate Gs=50 kg m⁻¹ s⁻¹. FIG. 9 graphically depicts the results of the simulations showing average axial particle velocity (x-axis) versus height (y-axis) for the co-current downer and the counter-current downer. The average axial particle velocity across the downer reactors show distinct behaviors for the co-current downer and the counter-current downers as the particles progress downward. In the co-current reactor, a noticeable escalation in particle velocity is observed, attributed to the gravitational force and the gas flow exerting pressure on the particles. Despite this increase, the particles seem to be still accelerating, suggesting they have yet to attain terminal velocity. Conversely, in the counter-current reactor, the upward gas flow acts as a retarding force, resulting in a comparatively lower particle velocity. Furthermore, the velocity distribution appears notably uniform in the counter-current configuration, suggesting the attainment of a more stable phase and possibly indicating the achievement of the third stage of acceleration.

FIG. 10 graphically depicts the results of the simulations showing average solid holdup (x-axis) versus height (y-axis) for the co-current downer and the counter-current downer. The counter-current reactor exhibits a higher average solid holdup due to the gas flow opposing gravity, which impedes particle movement. Consequently, the average solid holdup (i.e., particle volume fraction) is expected to rise compared to the co-current reactor. The counter-current reactor proves advantageous for processes demanding elevated solid holdup. The disparity between the two modes is quite notable, with the solid holdup increasing from approximately 1% in the co-current downer to 3.4% in the counter-current downer under identical conditions. This significant contrast highlights the distinctive behaviors and operational preferences inherent in the two reactor configurations that the counter-current downer displays shorter acceleration, faster system stability, and improved solid holdup.

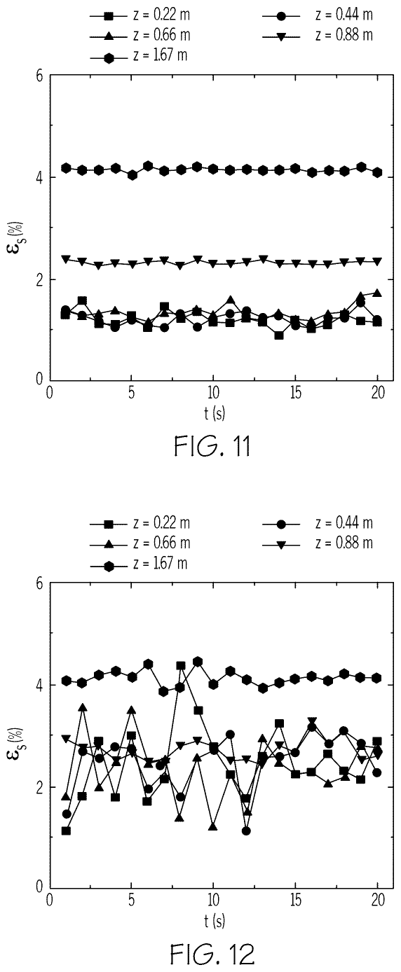

FIG. 11 graphically depicts the results of the simulations showing average solid holdup (y-axis) versus time (x-axis) at five selected heights for a co-current downer. It can be seen from FIG. 11 that in the co-current mode, the average particle volume fraction undergoes fluctuations in the initial half of the downer until it stabilizes into a steady flow of particles. Significantly, there is negligible variation in solid holdup over time in the co-current downer mode.

FIG. 12 graphically depicts modeling results showing average solid holdup (y-axis) versus time (x-axis) at the same five selected heights for a counter-current downer. It can be seen from FIG. 12 that in the counter-current mode, with the exception of the particle inlet zone (i.e., at a height of 1.67 m in the tube), height has minimal influence on the solid holdup. Further, the fluctuation of solid holdup is more pronounced than the co-current mode, indicating a steady dynamic environment with potential enhanced heat and mass transfer.

### Example 2: Counter-Current Reactor Experiment Using FCC Testing Unit

In Example 2, the concept of the FCC Testing Unit described herein is validated according to FIG. 1 using a fully circulated fluidized bed reactor with a regenerator. A zeolite-based catalyst was used for the FCC Testing Unit in Example 2. Specifically, the zeolite-based catalyst used for Example 2 contained a mixture of ZSM-5 zeolite and zeolite Y as active ingredients, an alumina/alumina silicate matrix material for the pre-cracking of large molecules, and fillers such as Kaolin to adjust the density for fluidization. The catalysts move in a downward direction through the counter-current downer reactor, and the crude oil flows upward in a counter-current contact pattern. The catalysts circulate continuously from the reactor to the regenerator at 675° C. to regenerate the catalysts by air flow, and to perform the reaction at 600° C. The system operates at a pressure from 1 to 2 bar. An Arabian Light Crude Oil with a flow rate of approximately 0.29 g/min was used for the FCC Testing Unit in Example 2. The total amount of catalysts in the loop (reactor, regenerator, transfer lines, stripper) is roughly around 300 grams to 500 grams. The product distribution is shown in Table 1. With a light olefin yield of more than 35 wt %, the feasibility of using the FCC Testing Unit to process crude light oil and to investigate the intrinsic kinetics of counter-current downer reactors has been demonstrated.

TABLE 1
Product Distribution for Example 2

| Component | Yield (wt. %) |
|---|---|
| H₂ | 1.0 |
| CH₄ | 4.7 |
| C₂H₆ | 4.3 |
| C₂H₄ | 11.3 |
| C₃H₈ | 5.7 |
| C₃H₆ | 15.1 |
| i-butane | 2.9 |
| n-butane | 1.3 |
| t-2-butene | 2.1 |
| 1-butene | 1.3 |
| cis-2-butene/isobutene | 4.0 |
| cis-2-butene/isobutene | 1.5 |
| i-pentane | 1.1 |
| pentane | 0.9 |
| 1-pentene | 0.1 |
| t-2-pentene | 1.1 |
| cis-2-pentene | 0.8 |
| i-hexane | 1.6 |
| n-hexane | 0.4 |
| Sum | 61.3 |
| C2═ + C3═ | 26.4 |
| C2═ + C3═ + C4═ | 35.3 |
| Coke | 6.1 |
| Liquids | 32.6 |

Overall, benefiting from the opposite moving directions of gas and solid particles and the uniform introduction of the crude oil using the fluids distribution ring, the FCC Testing Unit demonstrates reduced the acceleration zone with faster system stability, enhanced gas-solid interaction, and decreased heat and mass transfer limitations for providing reaction environments to investigate the intrinsic kinetics of FCC counter-current downer reactors. The reactor systems and methods described herein may be used to produce petrochemicals from hydrocarbons requiring less capital investment. The FCC Testing Unit using the counter-current downer as a main reactor demonstrates an easily operated laboratory-scale unit able to produce cracking data close to the industrial operations, for assessing the catalyst performance, operating conditions, and feed flexibility in this unique gas-solid contact pattern.

According to a first aspect of the present disclosure, a method for processing hydrocarbons comprises introducing a hydrocarbon feed stream into a reactor vessel through a hydrocarbon feed inlet proximate a bottom end of the reactor vessel by passing the hydrocarbon feed stream through a fluid distribution ring of the hydrocarbon feed inlet, introducing a catalyst into the reactor vessel through a catalyst inlet proximate a top end of the reactor vessel, and contacting the hydrocarbon feed stream with the catalyst in a reaction zone of the reactor vessel to produce a cracked hydrocarbon stream and a spent catalyst, wherein the hydrocarbon feed stream has a net upward superficial velocity through the reaction zone and the catalyst has a net downward superficial velocity through the reaction zone, wherein the fluid distribution ring comprises: a housing defining a central bore at an axial center of the housing and a distribution chamber surrounding the central bore in a radial direction and separated from the central bore by an inner wall; a fluid inlet extending through an outer wall of the housing from an exterior of the housing to the distribution chamber; and a plurality of distribution channels extending through the inner wall of the housing and fluidly connecting the distribution chamber to the central bore.

A second aspect includes the first aspect, wherein the central bore has a cylindrical shape and the distribution chamber has an annular shape.

A third aspect includes either one of the first or second aspects, wherein introducing the catalyst into the reactor vessel through the catalyst inlet comprises: passing a fluidization gas through a second fluid distribution ring into a catalyst container housing a catalyst feed, and passing the catalyst from the catalyst container to the catalyst inlet, wherein the second fluid distribution ring comprises: a second housing defining a second central bore at an axial center of the second housing and a second distribution chamber surrounding the second central bore in a radial direction and separated from the second central bore by a second inner wall; a second fluid inlet extending through a second outer wall of the second housing from an exterior of the second housing to the second distribution chamber; and a second plurality of distribution channels extending through the second inner wall of the second housing and fluidly connecting the second distribution chamber to the second central bore.

A fourth aspect includes the third aspect, wherein the second central bore has a first frustum shape and the second distribution chamber has a second frustum shape.

A fifth aspect includes any one of the first through fourth aspects, wherein the fluid distribution ring further comprises a mesh positioned between the central bore and the distribution chamber and configured to prevent the passage of particles from the central bore to the distribution chamber.

A sixth aspect includes any one of the first through fifth aspects, wherein each distribution channel of the plurality of distribution channels extends through the inner wall towards the central bore at an elevation angle β of greater than or equal to 10° and less than or equal to 80°.

A seventh aspect includes any one of the first through sixth aspects, wherein each distribution channel of the plurality of distribution channels has an equivalent diameter of greater than or equal to 3.175 mm (0.125 inches) and less than or equal 12.7 mm (0.5 inches).

An eighth aspect includes any one of the first through seventh aspects, wherein: the plurality of distribution channels comprises a first row of distribution channels and a second row of distribution channels, and wherein the distribution channels of the first row are staggered with respect to the distribution channels of the second row; the distribution channels of the first row are equally spaced about a circumference of the central bore at a first height h₁ of the central bore at which the distribution channels of the first row enter the central bore; and the distribution channels of the second row are equally spaced about a second circumference of the central bore at a second height h₂ of the central bore at which the distribution channels of the second row enter the central bore.

A ninth aspect includes the eighth aspect, wherein each of the first row of distribution channels and the second row of distribution channels comprises between 4 and 12 distribution channels.

A tenth aspect includes either one of the eighth or ninth aspects, wherein: the first row of distribution channels comprises a first circumferential spacing w₁ between adjacent distribution channels of greater than or equal to 3.175 mm (0.125 inches) and less than or equal 12.7 mm (0.5 inches); and the second row of distribution channels comprises a second circumferential spacing w₂ between adjacent distribution channels of greater than or equal to 3.175 mm (0.125 inches) and less than or equal 12.7 mm (0.5 inches).

An eleventh aspect includes any one of the eighth through tenth aspects, wherein the distribution channels of the first row enter the central bore at a first height h₁ and the distribution channels of the second row enter the central bore at a second height h₂, and wherein the first height h₁ and the second height h₂ define a vertical spacing t₁ of greater than or equal to 6.35 mm (0.25 inches) and less than or equal to 25.4 mm (1 inch).

A twelfth aspect includes any one of the first through eleventh aspects, wherein the method further comprises characterizing a product stream produced by the method to investigate intrinsic kinetics associated with process conditions, catalyst characteristics, and/or a composition of the hydrocarbon feed stream.

According to a thirteenth aspect of the present disclosure, a method for processing hydrocarbons comprises introducing a hydrocarbon feed stream into a reactor vessel through a hydrocarbon feed inlet proximate a bottom end of the reactor vessel, introducing a catalyst into the reactor vessel through a catalyst inlet proximate a top end of the reactor vessel, and contacting the hydrocarbon feed stream with the catalyst in a reaction zone of the reactor vessel to produce a cracked hydrocarbon stream and a spent catalyst, wherein the hydrocarbon feed stream has a net upward superficial velocity through the reaction zone and the catalyst has a net downward superficial velocity through the reaction zone, wherein the catalyst is introduced into the reactor vessel through the catalyst inlet proximate the top end of the reactor vessel by: passing a fluidization gas through a fluid distribution ring into a catalyst container housing a catalyst feed, and passing the catalyst from the catalyst container to the catalyst inlet, and wherein the fluid distribution ring comprises: a housing defining a central bore at an axial center of the housing and a distribution chamber surrounding the central bore in a radial direction and separated from the central bore by an inner wall; a fluid inlet extending through an outer wall of the housing from an exterior of the housing to the distribution chamber; and a plurality of distribution channels extending through the inner wall of the housing and fluidly connecting the distribution chamber to the central bore.

A fourteenth aspect includes the thirteenth aspect, wherein the central bore has a first frustum shape and the distribution chamber has a second frustum shape.

A fifteenth aspect includes either one of the thirteenth or fourteenth aspects, wherein the catalyst distributor comprises from 2 to 12 tubular branches, each tubular branch comprising a plurality of orifices on a circumferential portion of the tubular branch, wherein the tubular branches are spaced apart radially at an angle from 30° to 180°.

A sixteenth aspect includes the fifteenth aspect, wherein the catalyst distributor comprises from 2 to 12 tubular branches, each tubular branch comprising a plurality of orifices on a circumferential portion of the tubular branch, wherein the tubular branches are spaced apart radially at an angle from 30° to 180°.

A seventeenth aspect includes the fifteenth aspect, wherein the catalyst distributor comprises a top perforated plate, a bottom perforated plate, a distributor wall extending from the top perforated plate to the bottom perforated plate, and a conduit extending from an opening in the distributor wall to the catalyst inlet, such that the catalyst exits the catalyst distributor in an upward or downward vertical direction.

An eighteenth aspect includes the fifteenth aspect, wherein the catalyst distributor comprises a perforated plate extending across the reactor vessel, the perforated plate comprising a first plurality of perforations and a second plurality of perforations, wherein the first plurality of perforations are proximate the catalyst inlet and have an average area less than an average area of the second plurality of perforations.

A nineteenth aspect includes any one of the thirteenth through eighteenth aspects, wherein the method further comprises characterizing a product stream produced by the method to investigate intrinsic kinetics associated with process conditions, catalyst characteristics, and/or a composition of the hydrocarbon feed stream.

According to a twentieth aspect of the present disclosure, a fluidized catalytic cracking (FCC) system comprises: a reactor vessel comprising an elongated reaction tube having a substantially vertical orientation, a top end, and a bottom end; a hydrocarbon feed inlet proximate the bottom end of the reactor vessel; a catalyst inlet proximate the top end of the reactor vessel; a catalyst container configured to house a catalyst feed; and a fluid distribution ring comprising: a housing defining a central bore at an axial center of the housing and a distribution chamber surrounding the central bore in a radial direction and separated from the central bore by an inner wall; a fluid inlet extending through an outer wall of the housing from an exterior of the housing to the distribution chamber; and a plurality of distribution channels extending through the inner wall of the housing and fluidly connecting the distribution chamber to the central bore; wherein the FCC system is a laboratory-scale testing unit, and wherein: the hydrocarbon feed inlet comprises the fluid distribution ring, and wherein the fluid distribution ring is configured to inject the hydrocarbon feed stream into the reactor vessel; or the catalyst container comprises the fluid distribution ring, and wherein the fluid distribution ring is configured to fluidize the catalyst feed in the catalyst container.

The subject matter of the present disclosure has been described in detail and by reference to specific embodiments. It should be understood that any detailed description of a component or feature of an embodiment does not necessarily imply that the component or feature is essential to the particular embodiment or to any other embodiment. Further, it should be apparent to those skilled in the art that various modifications and variations can be made to the described embodiments without departing from the spirit and scope of the claimed subject matter.

For the purposes of describing and defining the present disclosure it is noted that the terms “about” or “approximately” are utilized in this disclosure to represent the inherent degree of uncertainty that may be attributed to any quantitative comparison, value, measurement, or other representation. The terms “about” and/or “approximately” are also utilized in this disclosure to represent the degree by which a quantitative representation may vary from a stated reference without resulting in a change in the basic function of the subject matter at issue.

It is noted that one or more of the following claims utilize the term “wherein” as a transitional phrase. For the purposes of defining the present technology, it is noted that this term is introduced in the claims as an open-ended transitional phrase that is used to introduce a recitation of a series of characteristics of the structure and should be interpreted in like manner as the more commonly used open-ended preamble term “comprising.”

It should be understood that where a first component is described as “comprising” a second component, it is contemplated that, in some embodiments, the first component “consists” or “consists essentially of” that second component. It should further be understood that where a first component is described as “comprising” a second component, it is contemplated that, in some embodiments, the first component comprises at least 10%, at least 20%, at least 30%, at least 40%, at least 50%, at least 60%, at least 70%, at least 80%, at least 90%, at least 95%, or even at least 99% that second component (where % can be weight % or molar %).

The transitional phrases “consisting of” and “consisting essentially of” may be interpreted to be subsets of the open-ended transitional phrases, such as “comprising” and “including,” such that any use of an open ended phrase to introduce a recitation of a series of elements, components, materials, or steps should be interpreted to also disclose recitation of the series of elements, components, materials, or steps using the closed terms “consisting of” and “consisting essentially of.” For example, the recitation of a composition “comprising” components A, B, and C should be interpreted as also disclosing a composition “consisting of” components A, B, and C as well as a composition “consisting essentially of” components A, B, and C.

It should be understood that any two quantitative values assigned to a property may constitute a range of that property, and all combinations of ranges formed from all stated quantitative values of a given property are contemplated in this disclosure. It should be appreciated that compositional ranges of a chemical constituent in a stream or in a reactor should be appreciated as containing, in some embodiments, a mixture of isomers of that constituent. For example, a compositional range specifying butylene may include a mixture of various isomers of butylene. It should be appreciated that the examples supply compositional ranges for various streams, and that the total amount of isomers of a particular chemical composition can constitute a range.

1. A method for processing hydrocarbons, the method comprising:
introducing a hydrocarbon feed stream into a reactor vessel through a hydrocarbon feed inlet proximate a bottom end of the reactor vessel by passing the hydrocarbon feed stream through a fluid distribution ring of the hydrocarbon feed inlet, wherein the fluid distribution ring comprises:
a housing defining a central bore at an axial center of the housing and a distribution chamber surrounding the central bore in a radial direction and separated from the central bore by an inner wall;
a fluid inlet extending through an outer wall of the housing from an exterior of the housing to the distribution chamber; and
a plurality of distribution channels extending through the inner wall of the housing and fluidly connecting the distribution chamber to the central bore;
introducing a catalyst into the reactor vessel through a catalyst inlet proximate a top end of the reactor vessel;
contacting the hydrocarbon feed stream with the catalyst in a reaction zone of the reactor vessel to produce a cracked hydrocarbon stream and a spent catalyst, wherein the hydrocarbon feed stream has a net upward superficial velocity through the reaction zone and the catalyst has a net downward superficial velocity through the reaction zone.

2. The method of claim 1, wherein the central bore has a cylindrical shape and the distribution chamber has an annular shape.

3. The method of claim 1, wherein introducing the catalyst into the reactor vessel through the catalyst inlet comprises:
passing a fluidization gas through a second fluid distribution ring into a catalyst container housing a catalyst feed, wherein the second fluid distribution ring comprises:
a second housing defining a second central bore at an axial center of the second housing and a second distribution chamber surrounding the second central bore in a radial direction and separated from the second central bore by a second inner wall;
a second fluid inlet extending through a second outer wall of the second housing from an exterior of the second housing to the second distribution chamber; and
a second plurality of distribution channels extending through the second inner wall of the second housing and fluidly connecting the second distribution chamber to the second central bore; and
passing the catalyst from the catalyst container to the catalyst inlet.

4. The method of claim 3, wherein the second central bore has a first frustum shape and the second distribution chamber has a second frustum shape.

5. The method of claim 1, wherein the fluid distribution ring further comprises a mesh positioned between the central bore and the distribution chamber and configured to prevent the passage of particles from the central bore to the distribution chamber.

6. The method of claim 1, wherein each distribution channel of the plurality of distribution channels extends through the inner wall towards the central bore at an elevation angle β of greater than or equal to 10° and less than or equal to 80°.

7. The method of claim 1, wherein each distribution channel of the plurality of distribution channels has an equivalent diameter of greater than or equal to 3.175 mm (0.125 inches) and less than or equal 12.7 mm (0.5 inches).

8. The method of claim 1, wherein:
the plurality of distribution channels comprises a first row of distribution channels and a second row of distribution channels, and wherein the distribution channels of the first row are staggered with respect to the distribution channels of the second row;
the distribution channels of the first row are equally spaced about a circumference of the central bore at a first height h₁ of the central bore at which the distribution channels of the first row enter the central bore; and
the distribution channels of the second row are equally spaced about a second circumference of the central bore at a second height h₂ of the central bore at which the distribution channels of the second row enter the central bore.

9. The method of claim 8, wherein each of the first row of distribution channels and the second row of distribution channels comprises between 4 and 12 distribution channels.

10. The method of claim 8, wherein:
the first row of distribution channels comprises a first circumferential spacing w₁ between adjacent distribution channels of greater than or equal to 3.175 mm (0.125 inches) and less than or equal 12.7 mm (0.5 inches); and
the second row of distribution channels comprises a second circumferential spacing w₂ between adjacent distribution channels of greater than or equal to 3.175 mm (0.125 inches) and less than or equal 12.7 mm (0.5 inches).

11. The method of claim 8, wherein the distribution channels of the first row enter the central bore at a first height h₁ and the distribution channels of the second row enter the central bore at a second height h₂, and wherein the first height h₁ and the second height h₂ define a vertical spacing t₁ of greater than or equal to 6.35 mm (0.25 inches) and less than or equal to 25.4 mm (1 inch).

12. The method of claim 1, further comprising characterizing a product stream produced by the method to investigate intrinsic kinetics associated with process conditions, catalyst characteristics, and/or a composition of the hydrocarbon feed stream.

13. A method for processing hydrocarbons, the method comprising:
introducing a hydrocarbon feed stream into a reactor vessel through a hydrocarbon feed inlet proximate a bottom end of the reactor vessel;
introducing a catalyst into the reactor vessel through a catalyst inlet proximate a top end of the reactor vessel by:
passing a fluidization gas through a fluid distribution ring into a catalyst container housing a catalyst feed, wherein the fluid distribution ring comprises:
a housing defining a central bore at an axial center of the housing and a distribution chamber surrounding the central bore in a radial direction and separated from the central bore by an inner wall;
a fluid inlet extending through an outer wall of the housing from an exterior of the housing to the distribution chamber; and
a plurality of distribution channels extending through the inner wall of the housing and fluidly connecting the distribution chamber to the central bore; and
passing the catalyst from the catalyst container to the catalyst inlet;
contacting the hydrocarbon feed stream with the catalyst in a reaction zone of the reactor vessel to produce a cracked hydrocarbon stream and a spent catalyst, wherein the hydrocarbon feed stream has a net upward superficial velocity through the reaction zone and the catalyst has a net downward superficial velocity through the reaction zone.

14. The method of claim 13, wherein the central bore has a first frustum shape and the distribution chamber has a second frustum shape.

15. The method of claim 13, wherein introducing the catalyst into the reactor vessel through the catalyst inlet further comprises passing the catalyst through a catalyst distributor that is coupled to the catalyst inlet and that extends into the reactor vessel.

16. The method of claim 15, wherein the catalyst distributor comprises from 2 to 12 tubular branches, each tubular branch comprising a plurality of orifices on a circumferential portion of the tubular branch, wherein the tubular branches are spaced apart radially at an angle from 30° to 180°.

17. The method of claim 15, wherein the catalyst distributor comprises a top perforated plate, a bottom perforated plate, a distributor wall extending from the top perforated plate to the bottom perforated plate, and a conduit extending from an opening in the distributor wall to the catalyst inlet, such that the catalyst exits the catalyst distributor in an upward or downward vertical direction.

18. The method of claim 15, wherein the catalyst distributor comprises a perforated plate extending across the reactor vessel, the perforated plate comprising a first plurality of perforations and a second plurality of perforations, wherein the first plurality of perforations are proximate the catalyst inlet and have an average area less than an average area of the second plurality of perforations.

19. The method of claim 13, further comprising characterizing a product stream produced by the method to investigate intrinsic kinetics associated with process conditions, catalyst characteristics, and/or a composition of the hydrocarbon feed stream.

20. A fluidized catalytic cracking (FCC) system comprising:
a reactor vessel comprising an elongated reaction tube having a substantially vertical orientation, a top end, and a bottom end;
a hydrocarbon feed inlet proximate the bottom end of the reactor vessel;
a catalyst inlet proximate the top end of the reactor vessel;
a catalyst container configured to house a catalyst feed; and
a fluid distribution ring comprising:
a housing defining a central bore at an axial center of the housing and a distribution chamber surrounding the central bore in a radial direction and separated from the central bore by an inner wall;
a fluid inlet extending through an outer wall of the housing from an exterior of the housing to the distribution chamber; and
a plurality of distribution channels extending through the inner wall of the housing and fluidly connecting the distribution chamber to the central bore;
wherein the FCC system is a laboratory-scale testing unit, and
wherein:
the hydrocarbon feed inlet comprises the fluid distribution ring, and wherein the fluid distribution ring is configured to inject the hydrocarbon feed stream into the reactor vessel; or
the catalyst container comprises the fluid distribution ring, and wherein the fluid distribution ring is configured to fluidize the catalyst feed in the catalyst container.
